(19) United States
(12) Patent Application Publication
(10) Pub. No.: US 2004/0043659 A1
(43) Pub. Date: Mar. 4, 2004

(54) Electrical connector having improved shielding member and method of making the same

(76) Inventor: Chin-Te Lai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/302,060

(22) Filed: Nov. 21, 2002

(30) Foreign Application Priority Data
Aug. 30, 2002 (TW) 91213584

(51) Int. Cl. H01R 13/648

(52) U.S. Cl. 439/607

(57) ABSTRACT

An electrical connector (1) has an insulative base (10), a shielding member (12) and a plurality of terminals (13) received in the insulative base. The insulative base includes a base plate (101) and a mating board (102) extending upward from the base plate and a pair of side portions (106) formed at lateral sides of the base plate. The base plate has a plurality of fixing members (105) and wedges (104). Each side portion defines a cavity therein and forms a flange on an inner wall thereof. The shielding member has a chamber (120) for accommodating the base plate and the mating board. The shielding member also has a pair of mating holes (123) and mating recesses (122) for mating with correspondingly wedges and fixing member of the base plate. The shielding member has a pair of lateral sides respectively received in corresponding cavities with bottom edges thereof abutting against corresponding flanges.

### CROSS-REFERENCE TO RELATED APPLICATION

The present application is related to a commonly assigned and contemporaneously filed U.S. patent application Ser. No. 10/143,616, filed on May 9, 2002, entitled “ELECTRICAL CONNECTOR SUPPORTED ON PRINTED CIRCUIT BOARD”. A copy of the specification is hereto attached.

### BACKGROUND OF THE INVENTION

1. Field of the Invention

The present invention relates to an electrical connector, and particularly to an electrical connector having an improved shielding member with its lower portion received in a housing of the connector.

2. Description of Related Art

It is becoming more and more desirable to provide shieldings around electrical connectors to protect signals transmitted therethrough from electromagnetic and radio frequency interferences (EMI/RFI). U.S. Pat. No. 6,322,396 B1, issued to Kuan on Nov. 27, 2001, discloses an electrical connector comprising an insulating base 1 having a plurality of terminal receiving slots 10, a metal shielding member 2 covering the external periphery of the insulative base 1 such that the insulative base 1 is shielded.

U.S. Pat. No. 6,371,809 Bi, issued to Chun-Yuan on Apr. 16, 2002, discloses an electrical connector comprising a rectangular insulating unit 1 defining a plurality of terminal accommodating grooves 10 respectively receiving terminals 3 therein and a metal integral enveloping unit 2 enveloping said insulating unit 1. However, the shielding member or integral enveloping unit is made of metal sheet and encloses the insulative base or insulative unit by bending the shielding member into a quadrangular configuration, so a slit is defined between free ends of the metal sheet, thus the shield will loosen from the insulative base because of outer external forces exerted thereon. Futhermore, some conventional electrical connectors have shielding members with their solder tabs and holding tabs integrated together. The holding tab will be affected by the solder tab when assembled the insulative housing into the shielding member, therefore making the shielding member loosen from the insulative housing. These conventional connectors are all individually produced which is not suitable for mass production.

Hence, an improved electrical connector is required to overcome the disadvantages of the related art.

### BRIEF SUMMARY OF THE INVENTION

An object of the present invention is to provide a method of making an electrical connector having an improved and integral shielding member reliable engaging with an insulative base.

An electrical connector according to the present invention comprises an insulative base, a shielding member and a plurality of terminals received in the insulative base. The insulative base has a base plate. The base plate has a top wall, a bottom wall, a first side wall and a second side wall. The base plate has a mating board extending upward from the top wall of the base plate. A plurality of fixing members and wedges are formed on the first side wall and the second side wall of the base plate. The mating board has a plurality of terminal receiving grooves. The shielding member has a chamber for accommodating the base plate and the mating board. The shielding member also has a pair of side walls and a chamber defined between the side walls. Each side wall has a pair of mating holes and mating recesses. A plurality of solder tabs extend from bottom edges of the side walls. Each terminal including a mating portion, a fixing portion extending from the mating portion, a bending portion extending perpendicularly to the fixing portion and a soldering portion extending parallel to the fixing portion. In assembly, each mating portion of the terminals is received in corresponding terminal receiving grooves. The shielding member shields the insulative base. The wedges and the fixing members respectively engage with corresponding mating holes and mating recesses. Each end of the shielding member is inserted into the receiving cavity.

A method of making the electrical connector is as following: providing the insulative base; providing the shielding member; providing the plurality of terminals; assembling the insulative base, the shielding member and the terminals together.

Other objects, advantages and novel features of the invention will more apparent from the following detailed description of the present embodiment when taken in conjunction with the accompanying drawings.

### BRIEF DESCRIPTION OF THE DRAWINGS

FIG. 1 is an exploded view of an electrical connector in accordance present invention.

FIG. 2 is an assembled view of the electrical connector shown in FIG.

FIG. 3 is another perspective view of FIG. 2.

### DETAILED DESCRIPTION OF THE INVENTION

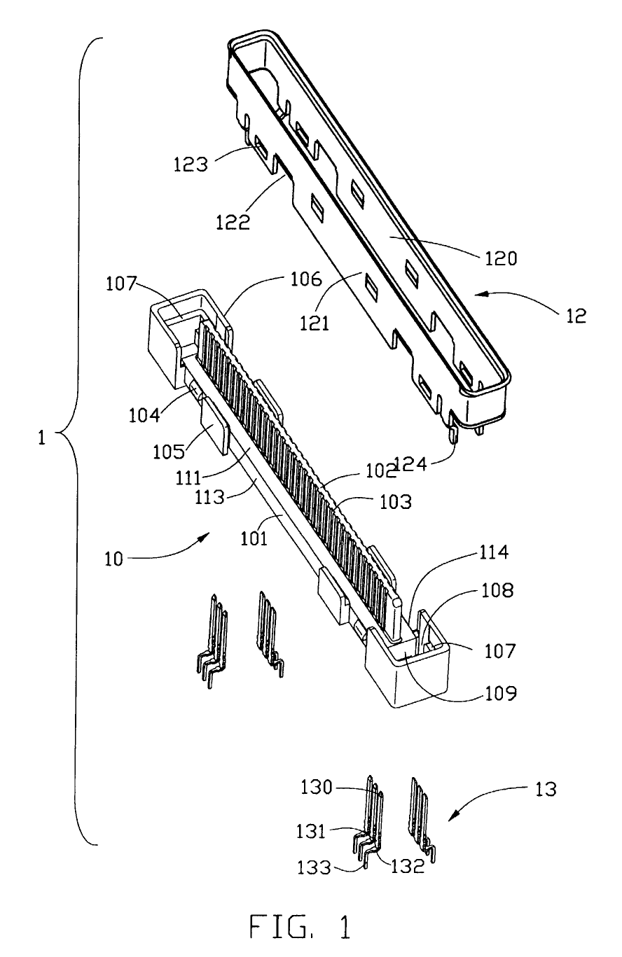

Referring to FIG. 1, an electrical connector 1 comprises an insulative base 10, a shielding member 12 and a plurality of terminals 13 received in the insulative base 10.

The insulative base 10 includes a base plate 101. The base plate 101 has a top wall 111, a bottom wall 112, a first side wall 113 and a second side wall 114. The base plate 101 has a mating board 102 extending upwardly from the top wall 111 of the base plate 101. The base plate 101 has a pair of side portions 106 symmetrically formed at two lateral sides of the base plate 101. Each of the first and second side walls 113, 114 of the base plate 101 has a plurality of fixing members 105 formed thereon. The base plate 101 also has a plurality of wedges 104 formed between the fixing members 105 and the side portions 106 on the first side wall 113 and the second side wall 114. The mating board 102 has a plurality of terminal receiving grooves 103 defined symmetrically at opposite sides. The side portions 106 each defines a receiving cavity 109 and forms a flange 107 on an inner wall thereof. Each side portion 106 defines a pair of channels 108 adjacent to the flanges 107 thereof.

The shielding member 12, drawn in an integral quadrangular configuration, has a pair of side walls 121 and a chamber 120 defined between the side walls 121 for accommodating the base plate 101 and the mating board 102. Each side wall 121 has a pair of mating holes 123 for engaging with corresponding wedges 104 of the base plate 101 and a pair of mating recesses 122 defined adjacent to corresponding mating holes 123 for receiving corresponding fixing members 105 of the first side wall and second side wall 113, 114 of the base plate 101. Each side wall 121 of the shielding member 12 has a pair of solder tabs 124 extending from bottom edges thereof.

Each terminal 13 has a mating portion 130, a fixing portion 131 extending from the mating portion 130, a bending portion 132 substantially bending perpendicularly to the fixing portion 131 and a soldering portion 133 extending from the bending portion 132 and substantially parallel to the mating portion 130.

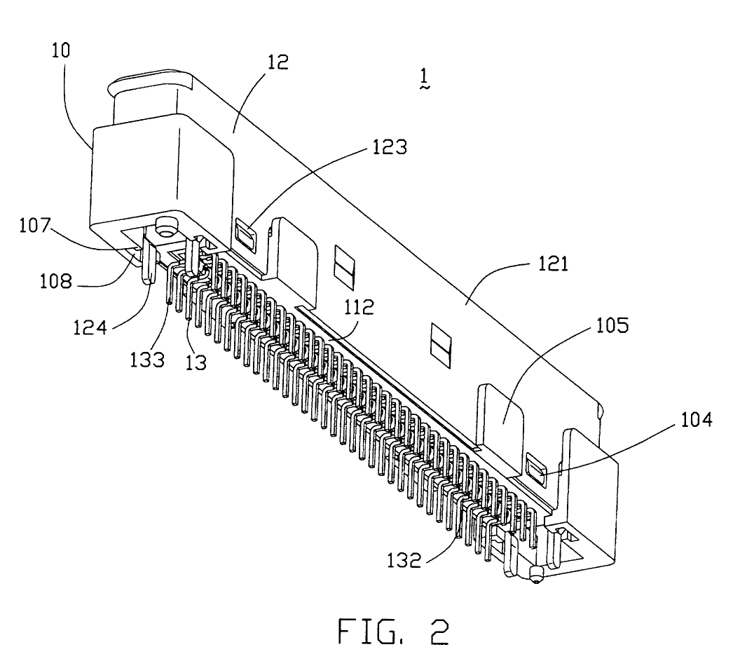

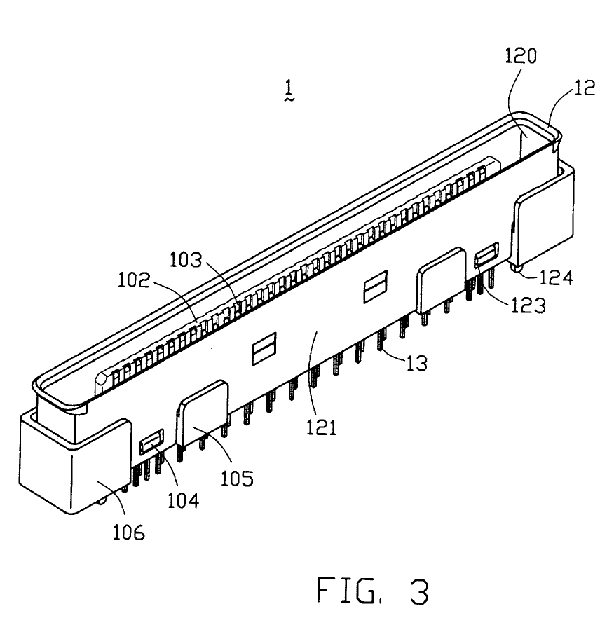

In assembly, as shown in FIGS. 1, 2 and 3, the mating portion 130 of the terminals 13 are respectively received in corresponding terminal receiving grooves 103 of the insulative base 10. The shielding member 12 is assembled to the insulative base 10 with the base plate 101 and the mating board 102 accommodated in the chamber 120 of the shielding member 12. The wedges 104 and the fixing member 105 of the insulative base 10 respectively engaging with the mating holes 123 and the mating recesses 122 of the shielding member 12. Each lateral side of the shielding member 12 is inserted into a corresponding receiving cavity 109 with a bottom edge abutting against the flange 107 of the receiving cavity 109. The plurality of solder tabs 124 extend through corresponding channels 108 of the insulative base 10 and project downwardly from the bottom surface of the insulative base 10.

A method of making the electrical connector 1 in accordance with the present invention has following steps:

(a) providing the insulative base 10.

(b) providing the shielding member 12, the shielding member drawn in an integral quadrangular configuration.

(c) providing the plurality of terminals 13.

(d) assembling the insulative base, the shielding member and the terminals

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising:
an insulative base including a central board for mating with a complementary connector, the insulative base further including a plurality of terminals each having a portion extending into the central board, the housing further defining peripheral wall; and
a shield attached to the peripheral wall of the housing, the shield including edges substantially received in a pocket defined in the peripheral wall.

2. The electrical connector as described in claim 1, wherein said insulative base has a mating board extending upward from the base plate.

3. The electrical connector as described in claim 1, wherein said shielding member is an integral enveloping unit.

4. The electrical connector as described in claim 2, wherein the mating board has a pair of side walls, each side wall defining a plurality of terminal receiving grooves.

5. The electrical connector as described in claim 3, wherein each terminal has a mating portion received in a corresponding receiving groove, a fixing portion extending from the mating portion, a bending portion substantially bending perpendicularly to the fixing portion and a soldering portion extending substantially parallel to the bending portion.

6. The electrical connector as described in claim 1, wherein the base plate has a first wall and a second wall, each wall having a wedge, and the shielding member has a pair of elongated side walls having receiving holes engaging with corresponding wedges of the base plate.

7. The electrical connector as described in claim 6, wherein each of the first and second walls has a rectangular fixing member, and each elongated side wall of the shielding member has a mating recess receiving corresponding fixing member.

8. The electrical connector as described in claim 1, wherein each side portion of the base plate has a flange formed on an inner wall thereof.

9. The electrical connector as described in claim 1, wherein the shielding member has a plurality of solder tabs extending downwardly from bottom edges of the side walls thereof.

10. The electrical connector as described in claim 8, wherein each side portion has a pair of channels and the solder tabs of the shielding member extending therethrough.

11. An electrical connector, comprising:
an insulative base including a central board for mating with a complementary connector, the insulative base further including a plurality of terminals each having a portion extending into the central board, the housing further defining peripheral wall;
a shield attached to the peripheral wall of the housing, the shield including edges substantially received in a pocket defined in the peripheral wall; and
interengaging means arranged between the shield and the housing so as to securely attach the shield to the housing.

12. A method of making an electrical connector comprising the steps of:
providing an insulative base, the insulative base including a mating board for received in a mating connector and a peripheral wall defining a receiving cavity;
providing a plurality of terminals;
providing a shielding member which including: positioning a metal plate connecting with a carrier between a top mold and a bottom mold, drawing an opening at a middle portion of the metal plate, with carrier connecting with a bottom edge of the metal plate;
assembling the plurality of terminals in the insulative base; and
assembling the shielding member to the insulative base with the bottom edge received in the receiving cavity.

13. An electrical connector comprising:
an rectangular insulative base with a mating board extending upwardly from a top face of the base;
a pair of U-shaped side portions formed at two lateral ends of the base and extending upwardly beyond the top face of the base;
a plurality of fixing members formed on elongated sides of the base;
a plurality of wedges formed on the elongated side of the base, said each of wedges being not aligned with any of the fixing members in a vertical direction;
a circumferential shield positioned upon the top face, enclosing the mating board, and circumferentially enclosed by said pair of U-shaped side portions and the fixing members; wherein
said shield includes mating holes receiving said wedges therein, respectively.

14. The connector as described in claim 13, wherein said shield further includes a plurality of solder tabs extending through a bottom face of the base inside the corresponding U-shaped side portions.
